(19) United States
(12) Patent Application Publication
(10) Pub. No.: US 2011/0101627 A1
(43) Pub. Date: May 5, 2011

(54) GASKET

(76) Inventors: Daniel D. Labrenz, Chula Vista, CA (US); Daniel J. Funke, San Diego, CA (US); Donald J. Peterson, Chula Vista, CA (US); Douglas C. Schenk, Chula Vista, CA (US)

(21) Appl. No.: 13/001,354

(22) PCT Filed: May 28, 2009
(86) PCT No.: PCT/US2009/045371

§ 371 Date: Dec. 23, 2010

Related U.S. Application Data
(60) Provisional application No. 61/075,159, filed on Jun. 24, 2008.
(60) Provisional application No. 61/145,135, filed on Jan. 16, 2009.
(60) Provisional application No. 61/148,148, filed on Jan. 29, 2009.

(51) Int. Cl. F16J 15/02; B23P 11/00

(52) U.S. Cl. 277/630; 277/650; 29/428

(57) ABSTRACT

A gasket (10) has a retainer (30) comprising a plurality of balls encapsulated within a matrix of polymeric material (e.g., rubber). The balls are made of hard material (e.g., metal, hard plastic, ceramic, etc.) and prevent over-compression during gasket installation. The polymeric matrix provides the gasket (10) with a two-dimensional grid of joints or elbows, allowing it to conform to an almost infinite number of different flange surfaces. The matrix can be made of the same material as, and molded at the same time as, the gasket's sealing elements (40, 50, 60).

A gasket can be used to seal the interface between components in a range of fluid assemblies (e.g., industrial, automotive aerospace, life science, oil, gas, etc.). The interfacing components typically each include a flange surrounding an opening communicating with a fluid chamber. A controlled-compression gasket typically comprises a rigid retainer having the primary role of preventing over-compression of seal elements during installation into the fluid assembly.

### SUMMARY

A gasket is provided wherein the retainer comprises a plurality of rigid balls interconnected to form an integral retaining structure. The interconnection of the balls is preferably accomplished by a polymeric matrix (that is compressible and flexible). The balls prevent over-compression of the gasket, and the polymeric matrix provides the retainer with an almost infinite number of elbows or joints. This combination allows the gasket to flex in the field to conform to different flange-surface geometries (e.g., planar, pitted, curved, stepped, etc.) without any compromise on over-compression protection. The matrix can be the same material as, and molded at the same time as, the gasket's sealing elements. And the gasket can be manufactured “flat” even when intended for installation between non-planar (e.g., pitted, curved, stepped, etc.) flange surfaces.

### DRAWINGS

FIGS. 1A-1C are each side views showing the gasket sealing a flange interface.

FIG. 2 is a plan view of the gasket.

FIG. 3 is a sectional view taken along line 3-3 in FIG. 2.

FIG. 4 is a sectional view taken along line 4-4 in FIG. 2.

FIGS. 5A-5G are close-up schematic views of the gasket's retainer and/or retaining structure.

FIGS. 6A-6D are schematic views showing a method of making the gasket.

FIGS. 7A-7D are schematic views showing another method of making the gasket.

FIGS. 8A-8C are schematic views showing another method of making the gasket.

### DESCRIPTION

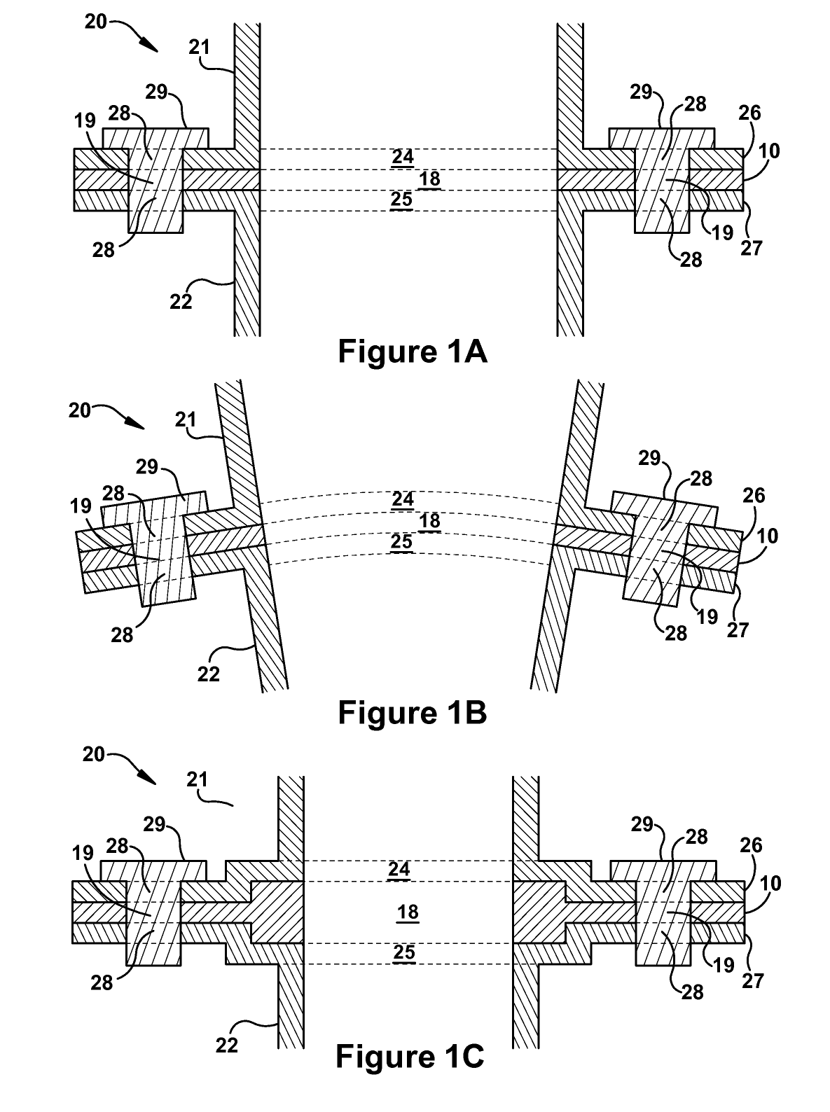

Referring now to the drawings, and initially to FIGS. 1A-1C, the gasket 10 is shown installed in a fluid assembly 20. The fluid assembly 20 comprises a first component 21 and a second component 22 that communicate with a fluid chamber 23 via openings 24 and 25. The components 21 and 22 have interfacing flange surfaces 26 and 27, respectively that surround the openings 24 and 25. The flanges can include holes 28 so that the components 21 and 22 can be clamped together with, for example, fasteners 29 (e.g., bolts). The flange pressure will be greater than a minimum flange pressure and not greater than a maximum flange pressure.

The gasket 10 seals the interface between these flange surfaces 26 and 27, to prevent leakage from (or into) the fluid chamber 23. The gasket 10 can be adapted to accommodate a planar flange interface (FIG. 1A), a curved interface (FIG. 1B), a stepped interface (FIG. 1C), and/or other regular or irregular interfaces.

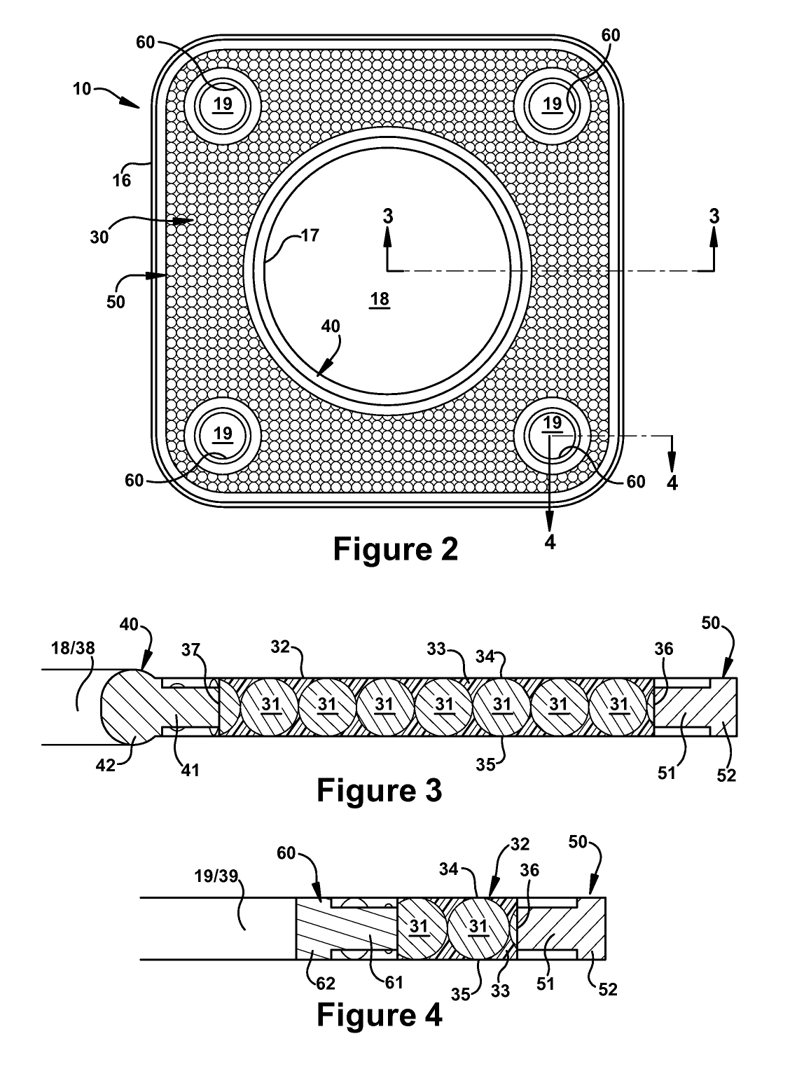

The gasket 10 is shown isolated from (and not yet installed in) the fluid assembly 20 in FIGS. 2-4. The overall geometry of the gasket 10 includes a radially outer perimeter 16 and radially inner perimeter 17 that defines an opening 18. The gasket's outer perimeter 16 corresponds to the boundary of the flange surfaces 26/27, and its inner perimeter 17 (and/or opening 18) corresponds to the flange's fluid openings 24/25. The illustrated gasket 10 also includes fastener holes 19 corresponding to the flange's fastener holes 28.

The gasket 10 comprises a retainer 30 comprising a plurality of balls 31 that are interconnected to form an integral retaining structure 32. “Integral” in the present context means that the structure 32 is a one-piece part that does not need further assembly for installation. The structure 32 is preferably (but not necessarily) formed in one-piece during the gasket-manufacturing process. In the illustrated embodiment, for example, a polymeric matrix 33 interconnects the balls 31 to form the integral retaining structure 32.

The retaining structure 32 has opposed radial faces 34 and 35, an outer axial edge 36 that extends axially between and radially around the faces 34/35, and an inner axial edge 37, that extends axially between and radially within the faces 34/35. The radial faces 34 and 35 contact the respective flange surfaces 26 and 27 in the fluid assembly 20, the distance therebetween defines the installation compression limit. The inner axial edge 37 defines an aperture 38 that corresponds to the gasket opening 18.

The retainer 30 and/or the retaining structure 32 can further comprise holes 39 corresponding to the fastener holes 19 in the gasket 10 and/or the fastener holes 28 in the fluid assembly 20 (See FIG. 4).

The gasket 10 additionally comprises a sealing rim 40 that encircles the retainer's inner axial edge 37. The rim 40 can have a proximate stem portion 41 adjacent the retainer edge 37 and a distal bead portion 42 projecting radially inward therefrom. The bead portion 42 can have a circular or bulb (in cross-section) shape that extends axially beyond one or both of the retainer faces 34/35. In the illustrated embodiment, the bead portion 42 defines the inner perimeter 17 of the gasket 10.

The gasket 10 can further comprise a peripheral hem 50 around the retainer's outer axial edge 36 and/or surrounding ledges 60 within the retainer's holes 19 (See FIG. 4). The hem 50 can have proximal portion 51 adjacent the retainer edge 36 and a distal portion 52 projecting radially outward therefrom (and it can define the gasket's outer perimeter 16). The ledges 60 can each have a proximate portion 62 adjacent the margin of the respective hole 39 and distal portion 61 extending radially inward therefrom (and thereby defining the holes 19 in the gasket 10). The proximate portions 51/61 can have an axial thickness less than that between the retainer faces 34/35; the distal portions 52/62 can have approximately the same thickness.

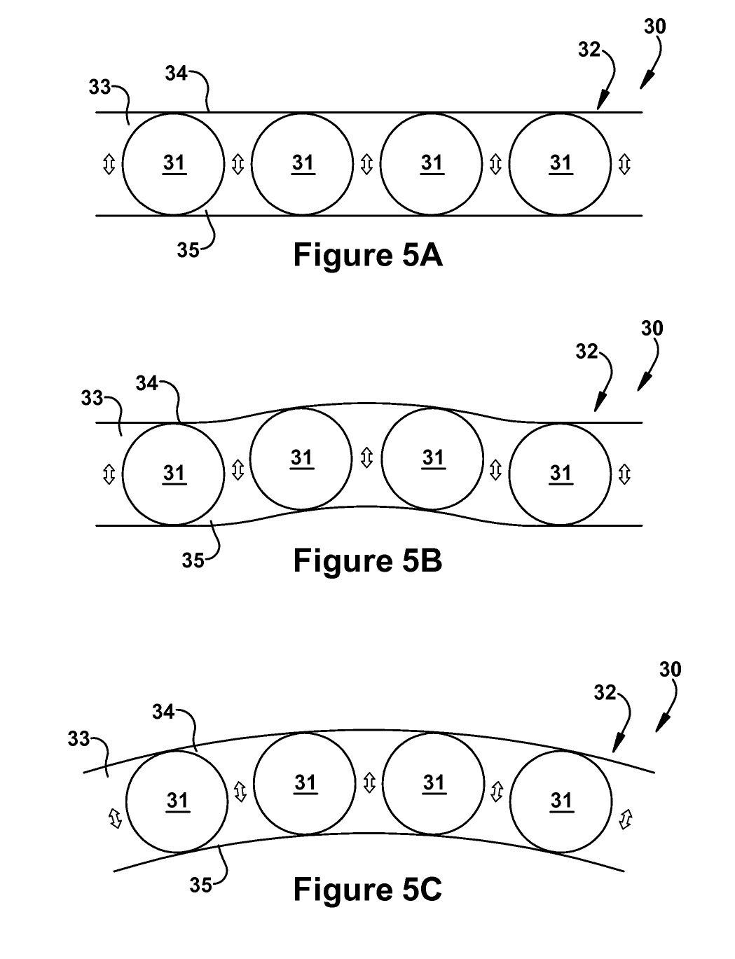

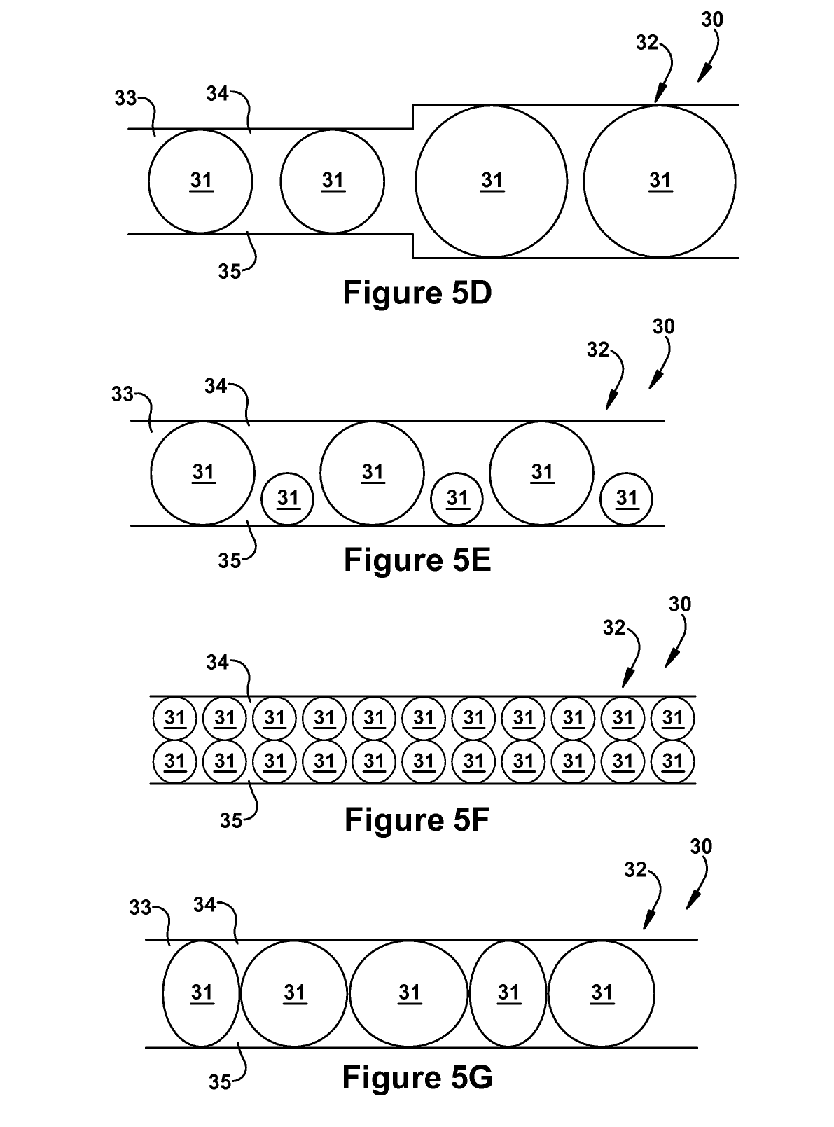

Referring now to FIGS. 5A-5G, the retainer 30 and/or the retaining structure 32 can be seen in more detail. The balls 31 are made of a hard material (e.g., metal, hard plastic, ceramic, etc.) that is non-compressible at the maximum flange pressure. The individual balls 31 can also (and usually will) be non-flexible, and their diameters define the retainer's radial faces 34 and 35. In this manner, the balls 31 prevent overcompression of the gasket's sealing elements (e.g., the rim 40) during installation.

The matrix 33 is preferably a polymeric material (e.g., rubber) that is flexible and can also (and usually will) be compressible at the minimum flange pressure. The polymeric matrix can be introduced during a molding step to encapsulate the balls 31, and/or fill the spaces therebetween and therearound so that the retaining structure 32 is a substantially solid, continuous (other than designed openings and holes) part. In the illustrated retainer 30, the matrix 33 is level with the “poles” of the balls 31 and forms the adjoining regions of the respective radial face 34/35. In some sealing situations, it may be undesirable for the polymeric matrix 33 to extend axially beyond the balls 31, as this may introduce a false sense of adequate compression during installation. On the other hand, total-ball encapsulation could offer positive corrosion resistance characteristics, as the balls 31 would not be exposed to the environment.

The flexible polymeric matrix 33 provides the retainer 30 (and thus the gasket 10) with a hinge, elbow, or joint between each adjacent ball 31 in the retaining structure 32. In other words, the gasket 10 has a two-way grid of joints, each of which can be flexed in plural directions, to conform to a particular surface. Thus the gasket 10 can conform to an enormous number of different surface profiles (e.g., this number being at least, and probably greater than, the factorial of the number of balls 31).

Specifically, for example, the retainer 30 can easily accommodate flat smooth flange surfaces (see e.g., FIGS. 1A and 5A.) And if the planar surfaces are less than perfect, (e.g., they have dents, pits, etc.), the same retaining structure 32 can flex in the problem areas to accommodate such imperfections (see e.g., FIG. 5B). The same retainer 30 can also accommodate curved flange surfaces (see e.g., FIGS. 1B and 5C.)

With a stepped flange surface, such as shown in FIG. 1C, the gasket 10 can bend as with a curved surface, or it can be fabricated with different sized balls 31. (FIG. 5D.) Different sized balls can also be used to increase joint flexibility by placing smaller balls between larger balls. (FIG. 5E.) The balls 31 can occupy a single layer, or can be compiled into multiple layers. (FIG. 5F.)

The balls 31 can be spherical, and conventional ball-bearings can easily used to manufacture the retainer 30. That being said, the tough tolerances typically imposed upon bearings will often not need to be so strict for the balls 31 forming the retaining structure 32. Discrete units that have chips or scrapes, or ones that are more oblong or egg-shaped may work acceptably well in many sealing situations (see e.g., FIG. 5G). Accordingly, the gasket 10 may provided an excellent recruitment opportunity for rejected ball bearings.

The dimensions of the balls 31 can depend upon manufacturing methods, sealing situations, and ball-array arrangements within the retaining structure 32. Some or all of the balls 31 can each have a diameter of between 0.10 cm and 0.30 cm, between 0.10 cm and 0.15 cm, between 0.15 cm and 0.17 cm, and/or between 0.15 and 0.20 cm. Additionally or alternatively, at least some or all of the balls 31 can have a diameter greater than 0.10 cm and/or less than 0.30 cm. In the case of non-spherical units 31, the diameter can be considered the dimension most likely to define the axial distance between the radial faces 34 and 35 in the retaining structure 32.

The ball density (i.e., the number of balls 31 per unit surface area of the face 34/35 of the retaining structure 32), and/or the ball-to-matrix ratio (i.e., the total volume occupied by the balls 31 versus the total volume occupied by the matrix 33) can differ depending upon manufacturing concerns and/or sealing situations. Generally, there should be enough balls 31 to provide suitable rigidity and acceptable over-compression protection, and enough matrix material to provide structural integrity and acceptable flexibility. And the relative cost of the balls 31 versus the polymeric matrix 32, may make it economically desirable to minimize one rather than the other.

The illustrated gasket 10 can have a ball density (i.e., number of balls 31 per unit surface area of the retaining structure 32) can be twenty to seventy balls (31) per cm² and/or thirty to sixty balls (31) per cm². Additionally or alternatively, the retaining structure 32 can have a ball density of less than seventy balls (31) per cm² and/or greater than twenty balls (31) per cm². The balls 31 can (but need not) be relatively evenly distributed throughout the retaining structure 32.

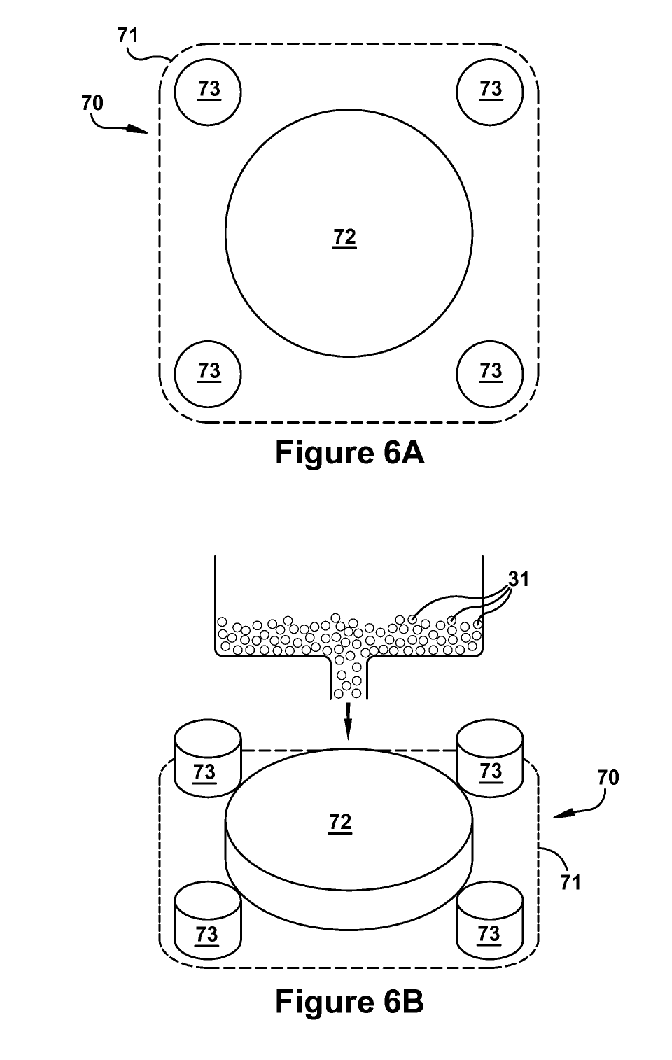

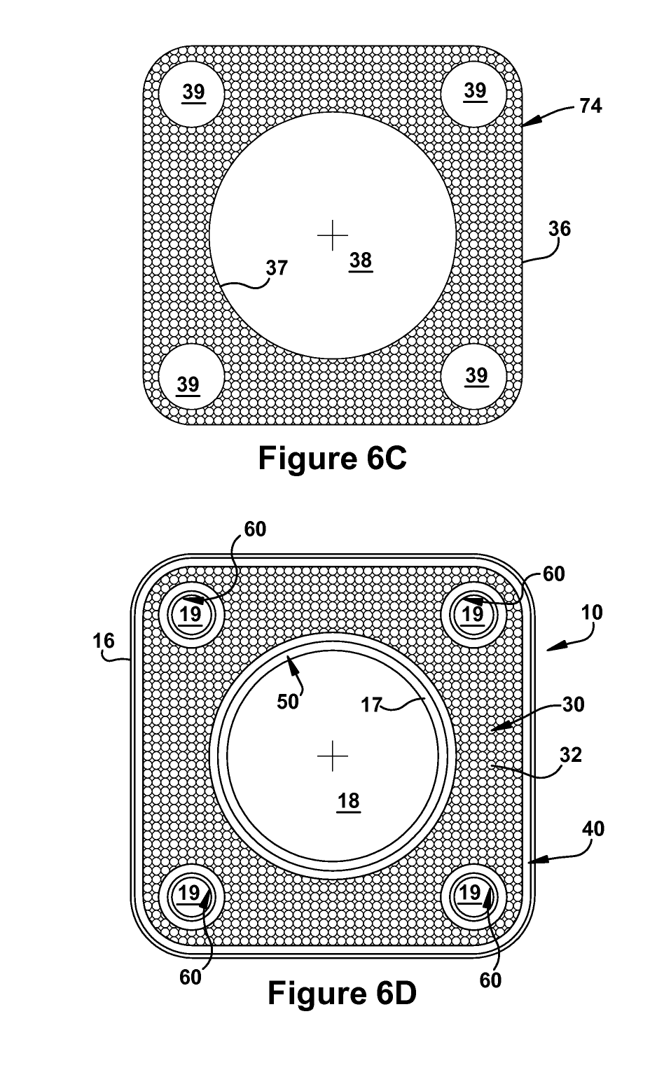

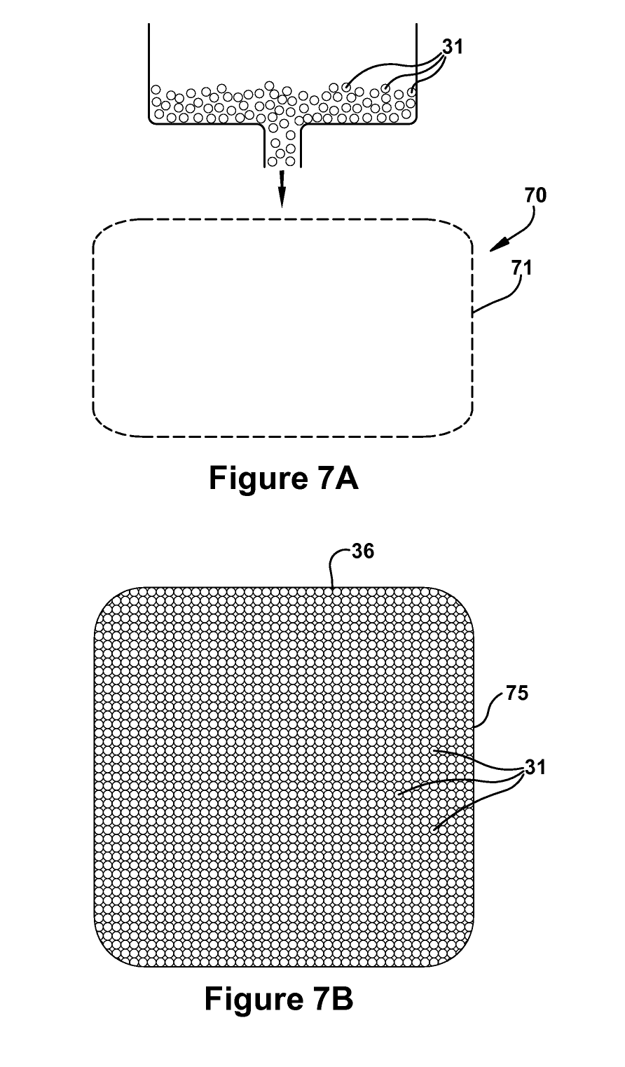

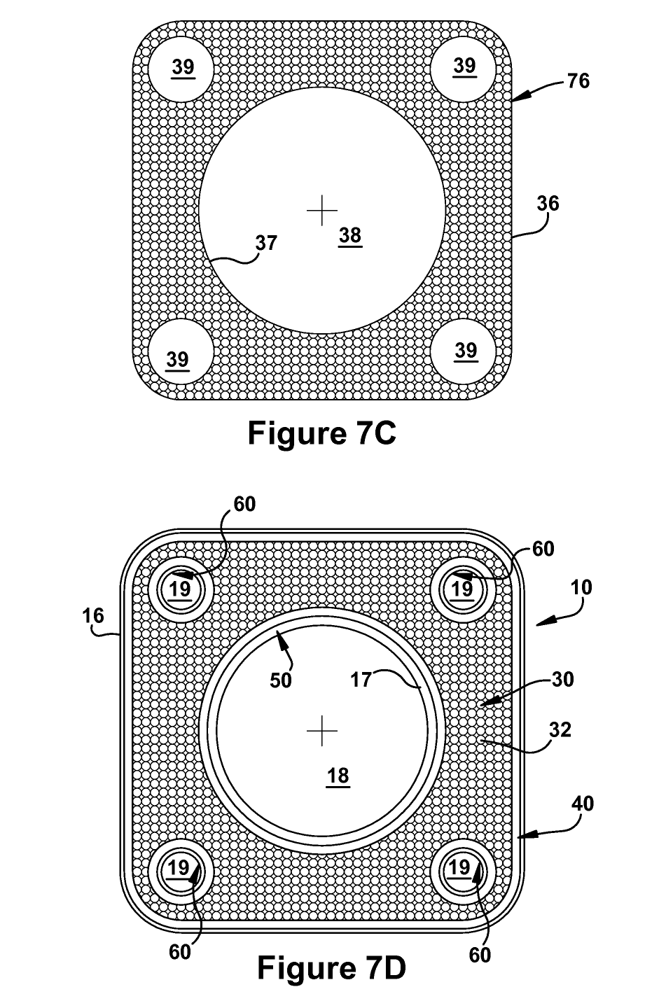

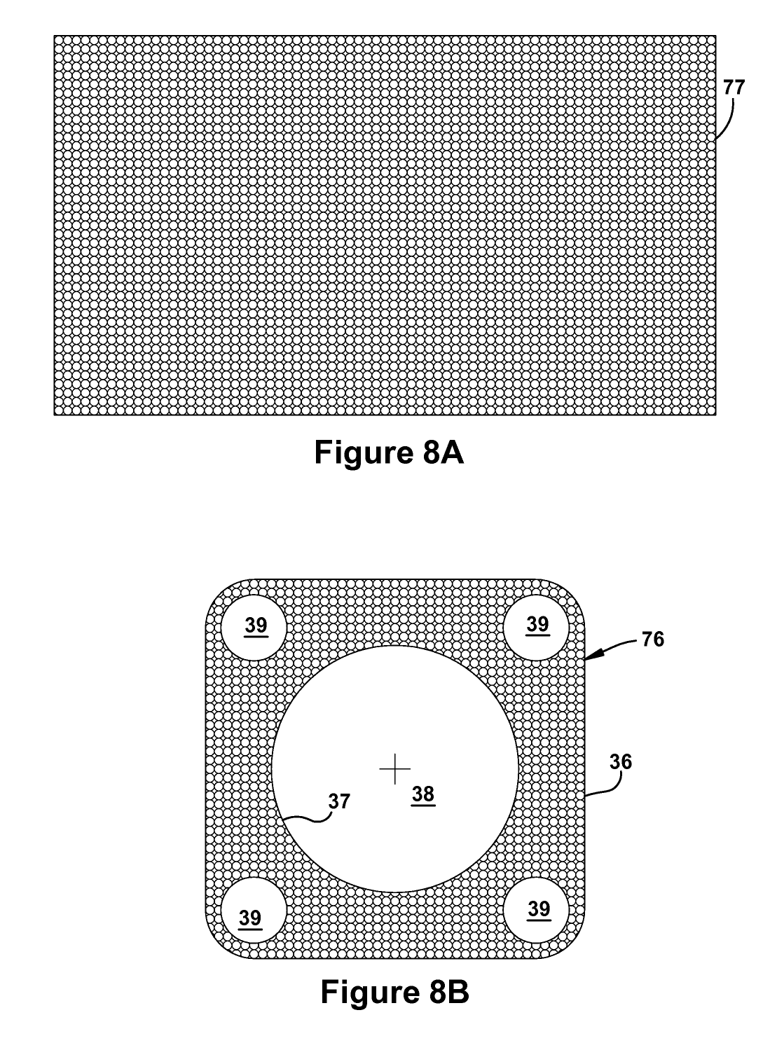

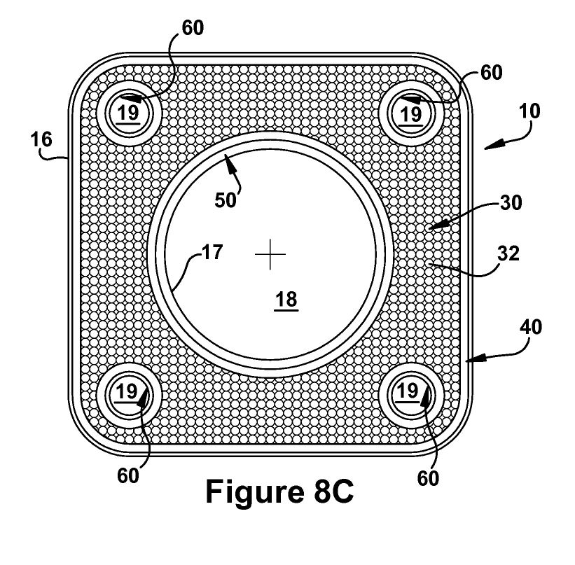

Referring now to the 6^{th} (FIGS. 6A-6D), 7^{th} (FIGS. 7A-7D), and 8^{th} (FIGS. 8A-8C) drawing sets, some possible methods for making the gasket 10 are schematically shown. In each of these methods, the gasket 10 is manufactured “flat” because, as indicated above, the retainer 30 can flex in the field to accommodate a particular installation surface. There is no need, for example, to manufacture “curved” gaskets for curved flanges. In fact, (although usually not practical), a “curved” gasket could be manufactured and then installed on a flat or planar flange surface.

Also in each of these methods, a molding step is performed wherein polymeric material is introduced to form the matrix 33 interconnecting the balls 31. (See FIGS. 6D, 7D, and 8C.) Prior to this molding step, the balls 31 can be treated with a chemical intended to enhance their bonding with and to the polymeric matrix 33, so as to insure the integrity of the retaining structure 32. Post-molding steps (e.g., vulcanizing, curing, etc.) can be performed to impart further desired properties.

The sealing rim 40, the peripheral hem 50, and/or the ledges 60 can be formed during the same molding step that forms the matrix 33. Thus, the elements 40/50/60 can be made from the same polymeric material as the matrix 33. This approach not only eliminates separate molding steps, but will in many cases promote the bonding of the elements 40/50/60 to the retainer 30. Specifically, for example, the matrix 33, the rim 40, the hem 50, and the ledges 60 are all formed in one-piece together, whereby the gasket 10 does not have any tear-susceptible seams, welds, or adhesive bonds.

In the method shown in FIGS. 6A-6D, a mold platform 70 is provided with a fence 71 corresponding to the outer axial edge 36 of the retaining structure 32. A post 72 corresponding to the aperture 38, and posts 73 corresponding to the holes 39, are situated within the fence 71. (FIG. 6A.) Individual (i.e., discrete, disconnected) balls 31 are corralled within the fence 71. (FIG. 6B.) The balls 31 array within the fence 71 and around the posts 72 and 73 to form a disconnected array 74 wherein the balls 31 are arranged to correspond to the retainer shape. (FIG. 6C.) The matrix 33, the rim 40, the hem 50, and the ledges 60 are then formed during a molding step. (FIG. 6D.) This method may require a set of custom mold accessories (e.g., fence 71, posts 72, 73) for each different gasket geometry.

In the method shown in FIGS. 7A-7D, the mold platform 70 has a fence 71, but not posts 72/73. The individual balls 31 are corralled within the fence 71 (FIG. 7A), temporarily (or loosely) bonded together to form an outline blank 75 (FIG. 7B), and the openings 38 and 39 are then formed in the blank 75 to form a featured blank 76 (FIG. 7C). The matrix 33, the rim 40, the hem 50, and the ledges 60 are then formed during a molding step. (FIG. 7D.) This method eliminates the need for custom posts 72/73 (but not a custom fence 71), and it requires a pre-bonding step. The openings 38 and 39 can be formed (e.g., cut, stamped, machined, etc.) during the same or separate steps.

In the method shown in FIGS. 8A-8C, a production strip 77 is provided, in which the balls 31 are temporarily (or loosely) bonded together. (FIG. 8A.) The strip 77 is then formed (e.g., cut, stamped, machined, etc.) into a featured blank 76 having an outer perimeter 36, and inner perimeter 37, an opening 38, and holes 39. (FIG. 8B.) The matrix 33, the rim 40, the hem 50, and the ledges 60 are then formed during a molding step. (FIG. 8C.) This method eliminates the need for the custom fence 71 and the posts 72/73 (but still requires a pre-bonding step). The perimeter 36, the opening 38, and the holes 39 can be simultaneously or sequentially formed.

In the methods shown in the 7^{th} and 8^{th} drawing sets, any cutting, machining, or stamping is performed prior to the molding step. This may be preferred if such activity causes the polymeric material introduced during molding to be susceptible to rips or tears. If this is not a concern, post-mold cutting of the openings 38 and 39 (and/or other features) may be a suitable approach. Also, forming the rim 40, the hem 50, and/or the ledges 60 during separate molding or other steps is possible and contemplated, and may even be preferred if advantages can be gained by using different matrix and sealing materials.

One may now appreciate that the gasket 10, retainer 30, and/or the retaining surface 32 can accommodate a large range of different flange contours, without any compromise on over-compression protection. Moreover, there is no need for the mold platform 70 (or other manufacturing equipment) to anticipate the profile of the flange interface. This may prove particularly useful when, for example, surfaces have unintended irregular contours (as opposed to designed) that must be accommodated in the fluid assembly 20.

Although the gasket 10, the retainer 30, the balls 31, the retaining structure 32, the matrix 33, sealing elements 40, 50, 60, related components, equipment, methods, and/or steps have been shown and described with respect to a certain embodiments, equivalent alterations and modifications should occur to others skilled in the art upon review of this specification and drawings. If an element (e.g., component, assembly, system, device, composition, method, process, step, means, etc.), has been described as performing a particular function or functions, this element corresponds to any functional equivalent (i.e., any element performing the same or equivalent function) thereof, regardless of whether it is structurally equivalent thereto. And while a particular feature may have been described with respect to less than all of the embodiments, such feature can be combined with one or more other features of the other embodiments.

1. A retainer for a gasket for clamping between two static flange surfaces, the retainer comprising a plurality of balls interconnected to from an integral retaining structure;
the retaining structure having opposed radial faces for contact with the respective flange surfaces, an outer axial edge extending axially between and radially around the opposed faces, and an inner axial edge extending axially between and radially within the opposed faces, wherein the inner axial edge defines an aperture corresponding to a fluid opening in the gasket;
wherein the balls are arranged in a two-dimensional planar array forming a two-way grid of joints each of which can be flexed in plural directions to conform to a particular surface.

2. A retainer as set forth in claim 1, wherein the aperture is circular in shape.

3. A retainer as set forth in claim 2, further comprising fastener-receiving holes arranged around the aperture.

4. A retainer as set forth in claim 1, wherein each of the balls is formed independently.

5. A retainer as set forth in claim 1, wherein the balls are made of metal.

6. A retainer as set forth in claim 1, wherein the balls are made of hard plastic.

7. A retainer as set forth in claim 1, wherein the balls are made of ceramic.

8-12. (canceled)

13. A retainer as set forth in claim 8, wherein at least some of the balls each have a diameter of between 0.15 cm and 0.20 cm.

14-18. (canceled)

19. A retainer as set forth in claim 1, wherein the retaining structure has a ball density of twenty to seventy balls per cm².

20-23. (canceled)

24. A retainer as set forth in claim 1, wherein at least some of the balls have an oblong shape.

25-27. (canceled)

28. A retainer as set forth in claim 1, wherein the balls are situated in a single level.

29. A retainer as set forth in claim 1, wherein the ball are situated in plural levels.

30. A retainer as set forth in claim 1, wherein the balls are interconnected by a matrix to form the retaining structure.

31. A retainer as set forth in claim 30, wherein the matrix comprises a polymeric material.

32. A retainer as set forth in claim 31, wherein the polymeric material comprises rubber.

33. (canceled)

34. A retainer as set forth in claim 30, wherein the matrix encapsulates the balls.

35. A retainer as set forth in claim 30, wherein the matrix is approximately level with the axial poles of the balls in the respective radial face of the retaining structure.

36. A method of making the retainer set forth in claim 1, said method comprising the steps:
forming the balls into a two-dimensional planar array corresponding to the retaining structure; and
interconnecting the arrayed balls;
whereby the retainer has a two-way grid of joints each of which can be flexed in plural directions to conform to a particular surface.

37. A method of making the retainer set forth in claim 1, said method comprising the steps:
forming the balls into a featured blank corresponding to the retaining structure; and
interconnecting the balls in the featured blank.

38-39. (canceled)

40. A gasket comprising a retainer as set forth in claim 1, and a sealing rim attached to the inner axial edge of the of the retaining structure.

41. A gasket as set forth in claim 40, wherein the sealing rim is made of the same material as a/the matrix interconnecting the balls.

42-45. (canceled)

46. A gasket as set forth in claim 42, wherein the rim's distal portion defines an inner perimeter surrounding an opening.

47. A gasket as set forth in claim 40, wherein the sealing rim is made from a polymeric material.

48. A gasket as set forth in claim 40, wherein the polymeric material comprises rubber.

49. (canceled)

50. A gasket comprising a retainer as set forth in claim 1, and a peripheral hem attached to the outer axial edge of the retaining structure.

51-65. (canceled)

66. A fluid assembly comprises a first component, a second component, and the gasket set forth in claim 40.

67-73. (canceled)
